(19) United States
(12) Patent Application Publication
(10) Pub. No.: US 2023/0367286 A1
(43) Pub. Date: Nov. 16, 2023

(54) INTELLIGENT COGNITIVE ASSISTANT SYSTEM AND METHOD

(71) Applicant: Technological University of The Shannon: Midlands Midwest, Limerick (IE)

(72) Inventor: Jacqueline HUMPHRIES, Thurles (IE)

(21) Appl. No.: 18/026,076

(22) PCT Filed: Sep. 14, 2021
(86) PCT No.: PCT/EP2021/075253

§ 371 Date: Mar. 13, 2023

(30) Foreign Application Priority Data
Sep. 14, 2020 (EP) 20195889.9

(51) Int. Cl. G05B 19/4063; G05B 13/02

(52) U.S. Cl. CPC G05B 19/4063; G05B 13/027; G05B 2219/32177; G05B 2219/32182

(57) ABSTRACT

A production process execution system has implementation modules which provide instructions for implementing the production process, recording modules which record the implemented steps of the production process, a control layer which monitors and controls the implementation modules and the recording modules, a cognition layer which monitors the production process, calculates process quality and provides feedback to a user through the implementation modules as to the correctness of the implemented steps. The system is enhanced by improvements in video recording, model training and digital recording of system operation and parameters. These features facilitate the creation of a closed system which provides user monitoring and system generated feedback.

### FIELD

The disclosure relates to manufacturing execution systems (MES) which are used in manufacturing to track and document the transformation of raw materials to finished goods. More particularly, this disclosure relates to systems and methods for intelligence augmentation of a human in a human-in-the-loop flexible manufacturing system in non-automated and semi-automated complex manufacturing.

### BACKGROUND

Whilst there has been considerable development from the MES perspective to allow for seamless integration of manufacturing and business processes, there has been little work on the seamless integration of the human into those processes. Current approaches require the human to control or interact with the interfaces such as reading from screens, input values, and selecting from menus. Thus, the system and the human are independent.

Based on the complexity of the system, information can be entered digitally or through a physical hardcopy which is then stored. In low-complexity systems where a physical hardcopy is stored, the MES does not receive information back from production. There is no confirmation received that a work order, or individual unit has been completed and as such this is an open loop system.

As part of a product's manufacture, a work instruction is also needed. These are often large, detailed documents and the level of information which they contain can lower usability and present difficulty in using them for reference by human users. This work instruction can be stored digitally or in hard copy, again, depending on the complexity of the manufacturing system.

As such, it is not only difficult for users to follow such a work instruction, it is also difficult to ensure that a work instruction has been followed. Currently, this is done through a quality inspection of the product, to ensure the manufacture is to standard. However, this does not ensure correct procedure was followed to achieve that standard. In addition, postproduction sampling is not sufficiently responsive in a fast-changing environment to deliver Zero Defect manufacturing. Real-time quality checks during assembly must be performed, making it possible to detect mismatches before any product loss occurs.

FIG. 1 depicts an open loop manufacturing execution system 1. The system can operate standalone to a MES system. Digital manufacturing information 3 is sent to peripheral technologies such as printers or displays 5 for a human user 9 to interpret from a hardcopy or softcopy Work Order 7. This work order contains the necessary manufacturing information 11 for the human to complete a product, such as raw materials to be used and the quantity of product to be produced. The human inputs manufacturing information to the work order 13, their unique identifier, the date, time, or other information depending on the complexity of the system, and whether the work order is in hard or softcopy form. The hardcopy form of the completed work order must then be retained 15.

The current view is that the skilled human is seen as a crucial resource for their capacity to manage the complexity of flexible manufacturing. Experiential knowledge, informal expertise, and tacit knowledge are essential even in routine assembly. So whilst humans induce quality errors, what currently saves the human from displacement in complex manufacture is that unique contribution they bring to successful execution of the manufacturing process.

There is a problem in manufacturing digitalization that huge quantities of data are being created and stored, that have to be processed, cleaned, analysed, commonly referred to as the ‘curse of dimensionality’. Traditionally, data can be stored in two types of queues: ‘First in, First out’ and ‘Last In, First out’. These are more commonly known as FIFO and LIFO respectively. An issue arises when a signal is received by a system using these data queuing techniques. The system may only capture data either before the event occurs, or after, but not both. This results in an inability to fully capture and contextualise all of the data relating to an event or events. The approach in other systems is to record everything, which can then be searched through if there is a problem, or alternatively post process the video record of the day's work by cutting it into time slices or applying AI to identify trends, all of which is prohibitively time consuming and requires significant processing capability.

European patent publication number EP 3 611 676, assigned to Boeing Co, discloses an automated supervision and inspection of an assembly process at an assembly site. The Boeing patent publication's primary function is the production of quality reports, supervision and inspection based on very large data sets (three dimensional global mapping). The Boeing system buses huge volumes of data, based on deep neural networks by generating three dimensional point clouds of the assembly site and production to which surface patches are fitted. The data processing requirements are exceptionally large. The required data to configure such as system suits the production to which it is employed i.e. assembly of plane wings etc. That is large scale production of large scale items. Deep neural networks such as this cannot satisfy real-time processing requirement without significant run-time memory cost to cope with the thick model architecture. The Boeing system is not suitable for flexible manufacturing where the product changes rapidly to batch size manufacturing.

There is therefore a need to provide an improved system and method for use in complex manufacturing execution systems (MES) to overcome at least one of the above mentioned problems.

### SUMMARY

In accordance with a first aspect of the invention there is provided, as set out in the appended claims, a production process execution system which comprises:
implementation modules which provide instructions for implementing the production process;
recording modules which record the implemented steps of the production process;
a control layer which monitors and controls the implementation modules and the recording modules;
a cognition layer which monitors the production process, calculates process quality and provides feedback to a user through the implementation modules as to the correctness of the implemented steps.

The provision of contextualised production instructions and assistance in real time through intelligence augmentation of humans/users according to the invention reduces the opportunity of error and the need for intensive management of quality in manufacturing. The present invention provides two primary functions two primary functions are (a) the provision of intelligence augmentation to the human through support, instruction and feedback so that the skilled operator in complex manufacturing is integrated into the system away from a supervisory system towards a collaborative system, and (b) the production of a digital record of the manufacture. The invention can generate a digital record of each production step in an image or video format with contextual data overlaid on the frames. This digital record has a unique configurability in terms of quality in frames-per-second, length of the video, and whether only critical parts of the process should be recorded so as to minimize the amount of data to be processed and stored.

In at least one embodiment, the cognition layer makes use of neural networks to identify one or more representations of the production process, from one or more sensors, to provide feedback.

The monitoring module can comprise multiple neural network vision-systems working in parallel, checking individual regions of interest which allow for a multi-dimensional representation of the object of interest, so as to achieve multi-factor confirmation. This permits thin neural networks which permits faster training and inference which can be installed on a common computer.

It will be appreciated that the thin neural networks trained initially can be further augmented by capturing knowledge from the video frames used in the multi-factor confirmation that have passed the confidence index; frames that capture new, better or alternative execution of the process are collated and fed back into the neural network; the neural network is retrained. This allows for the creation of a model which is able to account for nuances or tacit knowledge such as how an object was held, positioning, background, lumens of the environment etc., which it is testing for the presence of the trained model.

In at least one embodiment of the present invention, the feedback comprises a system wide signal confirmation of a step complete state.

In at least one embodiment of the invention, the control layer receives instructions on production requirements, human-authentication, location and context-specific information and provides context-specific instructions to the user.

In at least one embodiment of the invention, the control layer takes a record of the production process and the associated production data at each stage in production process as received from the recording modules.

In at least one embodiment of the invention the system uses data transfer protocols to receive production instructions from external production lifecycle manufacturing systems and manufacturing execution systems.

In at least one embodiment of the invention the system operate as a standalone system. It will be appreciated that the system does not integrate to production lifecycle manufacturing systems and manufacturing execution systems, with process data being stored within the independent system.

In at least one embodiment of the invention the system uses data transfer protocols to send production process completion information to those external systems automatically without the need for user input.

In at least one embodiment of the invention, the system manages multi-user concurrent access across a range of manufacturing use-cases.

In at least one embodiment of the invention the system uses cloud-based services, fog-computing, edge-computing, networked-computing, or local-computing.

In at least one embodiment of the invention, the cognition layer uses multi-threading to achieve real-time performance.

In at least one embodiment of the invention a series of class objects represent the production process, link the trained models, the video, aural and image assets, and any camera configurations to the corresponding sub-step.

In at least one embodiment of the invention, the Cognition Layer makes use of neural networks to identify one or more representations of the production process, from one or more sensors, to produce a system wide signal confirming the step complete state.

In at least one embodiment of the invention the monitoring modules comprise sensors which monitor manufacturing variables including temperature, pressure, tolerances.

In at least one embodiment of the invention the manufacturing variables are captured and overlaid on frames or images then stored as a permanent record of production.

In at least one embodiment of the invention the monitoring or digital record module includes a video monitor which can capture one or more video frames of the user undertaking a task during the production process and store the video frames with a unique job identifier.

In at least one embodiment of the invention, the production process execution system can flag uniquely identified objects to be checked for compliance to quality.

In at least one embodiment of the invention, the monitoring module comprises an artificial intelligence vision system.

In at least one embodiment of the invention, a flag can be turned on when the artificial intelligence vision system determines that the user is not working in line with the implemented steps.

In at least one embodiment of the invention, the implementation modules load just-in-time context-specific intelligence, product line information and code executed for each stage of the manufacturing process.

In at least one embodiment of the invention, the implementation modules display context specific instructions as to the next part of production process to the human, through a multiplicity of signals.

In at least one embodiment of the invention the monitoring modules transfer multiple live video stream feeds to the control layer.

In at least one embodiment of the invention the cognition layer recognizes within those video stream feeds the desired state of the object, by comparison to image-based neural networks.

In at least one embodiment of the invention the cognition layer generates a state-achieved signal once a desired step complete state has been achieved.

In at least one embodiment of the invention confirming feedback is provided to the user through a user interface on receipt of the step-complete signal.

In at least one embodiment of the invention the next steps to be executed are presented to the user on receipt of the step-complete signal.

In at least one embodiment of the invention, the production process can be split into sub-stages, so as to allow multiple users to operate concurrently for load balancing.

In at least one embodiment of the invention, receipt of the step-complete signal causes a video or digital record to be taken that of a predetermined time before the signal and a predetermined time after the signal.

In at least one embodiment of the invention, the predetermined time before the signal and the predetermined time after the signal have the same length. Thus a record of what the user did immediately before, at, and immediately after the critical assembly is kept, in this way unnecessary frames of the scene are not stored.

In at least one embodiment of the invention the video record is of a configurable quality in frames-per-second, so as to minimize the amount of data to be processed and stored. In this way, one frame to any maximum of frames can be stored as a record. Different frame rates can be set for different parts of the process thus optimising storage.

In at least one embodiment of the invention, specified critical parts of the process, and those critical to quality can be captured, thus only the relevant parts of the process, as flagged, are stored.

In at least one embodiment of the invention, on receipt of the step complete signal, a light is activated to confirm to the human that the step has been completed satisfactorily.

In at least one embodiment of the invention, on receipt of the step-complete signal, a relay is activated to produce a sound to confirm to the human that step has been completed satisfactorily.

In at least one embodiment of the invention, the monitoring modules comprise a silent monitor or silent partner which monitors the user during the execution of their work, and provides assistance to the user if the cognition layer determines that the user needs assistance.

Advantageously, where the user receives the information at the right time, in the right place, within the right context, thus they receive a context-specific feed of instructions.

In at least one embodiment of the invention, the cognition layer comprises an image-based neural network as a vision system to classify and locate objects.

In at least one embodiment of the invention, the monitoring module comprises multiple neural network vision-systems working in parallel, checking individual regions of interest which allow for a multi-dimensional representation of the object of interest, so as to achieve multi-factor confirmation. In this way signaling to the user is achieved confirming that the assembly is correct from all angles. In so doing, better quality checking is performed as being performed from many angles, and checking operates faster that it would do from one angle which may be obscured from the camera.

In at least one embodiment of the invention, wherein the monitoring module comprises neural networks which identify the location of an object and establish a datum such that future regions of interest are then established from this datum for the location of future models, reducing the impact of changes to equipment set ups, and potential moving of the vision system.

In at least one embodiment of the invention, a manual override to the pointed region of interest can be activated, whereby the camera or the objects can be moved, by human or machine, so that a visible frame of reference, such as may be displayed with a bounding box, is aligned with an appropriate image that the neural net is looking for.

In at least one embodiment of the invention, the cognition layer comprises a neural network image training set, preferably a thin neural network. In one embodiment the cognition layer comprises multiple thin neural networks working in parallel focused on a region of interest configured to perform image recognition in real time

In at least one embodiment of the invention, the cognition layer operates by taking a single image given by the human and performing a number of alterations to that image in order to create a very large data set which creates and captures variances within the data and allows for generalizations within the data wherein the data set is then given to the neural network to complete the training of a model

In at least one embodiment of the invention, said images are made transparent, cropped, rotated, and have different backgrounds, lights and shadows applied.

Advantageously, the process steps can be applied in any order.

In at least one embodiment of the invention, the cognition layer captures knowledge captured from the video frames used in the multi-factor confirmation to retrain the neural network so that new and better, or alternative processes can be captured.

In at least one embodiment of the invention the neural networks can be retrained with images taken from previous approved states.

In at least one embodiment of the invention the images will have been approved previously via a confidence index threshold (cit), thus images will have a confidence index somewhere between cit and 1.

In accordance with a second aspect of the invention there is provided a method for creating a video digital record of an event, the method comprising the steps of:
capturing live video;
passing the captured video frames through a queue-based data structure which defines a queue length for the video frames;
receiving a notification that an event of interest has occurred;
locating a predetermined number of frames in the queue based structure which were recorded before and after the time at which the event of interest occurred; and
retaining the predetermined number of frames for inspection or analysis.

In at least one embodiment, the method is used to create a video record in the production process execution system in accordance with the first aspect of the invention.

In at least one embodiment, the queue length is configurable by a user.

In at least one embodiment, a frame rate for the video frames is configurable by a user.

In at least one embodiment, the queue length and/or the frame rate can be adjusted based on the event which is being monitored.

In at least one embodiment, the video digital record is created by having a video camera viewing an area of interest.

In at least one embodiment, the video camera captures live video frames constantly.

In at least one embodiment, the video frames are passed through the queue-based data structure on a first in, first out basis.

In at least one embodiment, the notification that an event of interest has occurred is provided by an AI-driven vision system.

In at least one embodiment, the notification that an event of interest has occurred is provided by an IoT sensor.

In at least one embodiment, the video frames to be stored from the queue-based data structure use centre forward and backward first in first out, essentially a Centre Forward Centre Backward (CFCB) queue from the notification point that an event of interest has occurred.

In at least one embodiment, the method of the second aspect of the invention is used to create a video record in the production process execution system of the first aspect of the invention.

In accordance with a third aspect of the invention there is provided a method for training a model to recognise features in an image, the method comprising the steps of:
creating an image-based dataset with which to train a model by:
receiving an image;
performing one or more alteration to the image data file to create a dataset;
providing the dataset to a neural network as training data; and training the model.

In at least one embodiment, the method is used to create a neural network image training set in accordance with the first aspect of the invention.

In at least one embodiment, the alterations are carried out in series such that subsequent alterations are performed on previously altered images.

In at least one embodiment, the alterations are carried out on a previously altered image.

In at least one embodiment, the alterations are carried out on an immediately previously altered image.

In at least one embodiment the invention is used for the training of image based neural networks which work in conjunction with vision systems.

In at least one embodiment, alterations comprise a plurality of alterations.

In at least one embodiment, alterations comprise the removal of the background of the image by making it transparent.

Advantageously, this allows the picture to focus on the item and remove reliance on the background of the scene.

In at least one embodiment, the image with transparent background is cropped and re-scaled x number of times.

Advantageously, this enables a model to be trained to account for the scale of the item it is looking for, meaning the model can be detected at a greater range of distances to the camera. Also, the camera can identify the item if not all of the item is within the frame, i.e. a portion of the item missing out of frame.

In at least one embodiment, the cropped image is rotated at a number of increments of degrees between 0° and 360°.

In at least one embodiment, the increments of degrees, y, is variable ranging from 1 to 360 degrees. to allow the vision system to correctly identify the object from many different angles, meaning that the trained model is now rotation invariant.

In at least one embodiment, a number of background images, b, are added in order to represent the item being viewed in different scenes.

In at least one embodiment, the background scenes represent the likely scenes in which the item may be viewed for example a person may be positioned on a road, at a desk or in a landscape. A manufacturing component might be positioned on a workbench which was coloured black, stainless steel, white, or grey background.

In at least one embodiment, a number of light effects, e, are added to the images.

In at least one embodiment, these include contrast or pixel intensity. This allows for the creation of a model which is able to account for changes in the lumens of the environment which it is testing for the presence of the trained model.

In at least one embodiment, the images are saved and added to a collective data set, which can be used to train a machine learning model.

In at least one embodiment a number of variant images can be generated and added to the data set, allowing for the creation of a more robust model.

In at least one embodiment, the dataset is large with respect to the amount of data in the original image.

In at least one embodiment, the method of the method of the third aspect of the invention is used to train a model to recognize features in an image in the production process execution system of the first aspect of the invention.

In accordance with a fourth aspect of the invention there is provided a method for creating a digital record of a manufacturing process, the system comprising: monitoring the manufacturing process
identifying when a manufacturing step or steps of the manufacturing process are complete, wherein upon completion of a step, the monitor captures a video record of the step.

In at least one embodiment, the video record is saved to a database along with a number of key process variables.

In at least one embodiment, the method is used to create a video record of the production process neural network image training set in accordance with the first aspect of the invention.

In at least one embodiment, the method is used to create a record in accordance with the first aspect of the invention.

In at least one embodiment the key variable comprises one or more of operator ID, Product type, Unit Number, a Lot to which that unit belongs and a timestamp.

In at least one embodiment, data relevant to the manufacturing process is recorded.

In at least one embodiment the data record comprises manufacturing variables, such as temperature, pressure or tolerances.

In at least one embodiment, the data for quality control, traceability and accountability in real time, that encompasses visual and textual data.

In at least one embodiment, the monitor is an industrial vision system.

In at least one embodiment the method monitors a complex manufacturing process through the use of an Industrial Vision System.

In at least one embodiment the method uses trained Neural Networks to identify when a manufacturing step or steps are complete.

In at least one embodiment, upon completion of a step, a video record is captured.

In at least one embodiment the video record is saved to a database along with a number of key process variables such as the operator ID, the Product type and the Unit Number, the Lot to which that unit belongs and a timestamp.

This data can also include important manufacturing variables, such as temperature, pressure or tolerances.

In at least one embodiment, the method of the fourth aspect of the invention is used to create a digital record of a manufacturing process in the production process execution system of the first aspect of the invention.

In one embodiment there is provided production process execution system which provides cognitive augmentation to enable a human-in-the-loop manufacturing closed system for complex non-automated and semi-automated production processes which comprises:
implementation modules which provide context-specific instructions and intelligence and pre-attentive feedback to the human for the implementation of the production process, the type of instructions and feedback channels are configured for each human's preferences;
recording modules which temporarily push video frames of the executed steps of the production process in a data queue, on receipt of a signal that assembly is complete save a specified number of configurable frames in a digital/video record, overlap contextual data on the video frames, and save the assembly record;
a control layer which monitors and controls the implementation modules and the recording modules;
a cognition layer which monitors the execution of production process by a user, calculates process quality and provides feedback and instruction to a human through the implementation modules as to the correctness of the implemented steps; continues to re-evaluate execution during real-time reattempts of the assembly; generates on-going assistance if needed; generate flags for quality control for targeted quality function.

In one embodiment digital record module includes a video monitor which can capture video frames of the human undertaking a task during the production process; wherein the captured video frames are passed through a queue-based data structure which is configurable to define a queue length, and frame rate for the video frames; wherein frames not of interest to the digital record are removed from the queue; wherein a notification that an event of interest has occurred is received; wherein a predetermined number of frames in the queue based structure which were recorded before and after the time at which the event of interest occurred and retrieved thus the minimum amount of critical frames are retained; wherein data pertaining to the digital record is overlaid on the video; wherein the predetermined number of frames for inspection or analysis are retained.

In one embodiment a flag is turned on when the system determines that the user is not working in line with the implemented steps; wherein the flag is stored with the digital record; identifies this assembly for quality checks; and generates a quality report using the digital records highlighted for quality control attention.

In one embodiment the monitoring modules comprises of a silent monitor or partner which provides intelligence augmentation to an experienced human; wherein the cognition module silently monitors the human during the execution of their work, flags work not being executed as per process for quality checking, alerts the human, prompts the human as to the correct process and provides necessary instruction if the cognition layer determines that the human needs assistance; provides the human the opportunity to correct the assembly.

In one embodiment specified steps in the assembly which are flagged as Critical to Quality can be treated differently to other steps; wherein a configuration setting is made available to turn on specific settings such as flag and recording settings; Critical to Quality flag is communicated to the human so that attention is targeted to those steps; wherein these steps can be recorded at higher frame rates and greater resolutions for minute fine-tuned accuracy reporting than other steps; digital/video records of assembly of only Critical to Quality steps can be captured in the digital/video record thus only the relevant parts of the process are stored; wherein the number of digital/video records are reduced for storage, processing and analysis so that the record is close to its intrinsic dimension.

In one embodiment the monitoring module comprises one or more neural network vision-systems working in parallel; wherein focus for each vision system is on an individual small region of interest at different fixed reference lines; activates a thin neural network for vision systems for each camera; allocates each neural network inference to a unique processing thread for improved parallel processing performance; evaluates images feed through the vision system to the relevant active thin neural network model as to whether the confidence index threshold for that thin neural network is passed; performs a logical conjunction; confirms the step is complete thereby providing multi-factor confirmation.

In one embodiment the monitoring module comprises neural networks which identify the location of an object and establish a datum such that future regions of interest are then established from this datum for the location of future steps thereby reduces the impact of changes to equipment set ups and potential movement of the vision system cameras field of view; enables the region of interest to be repositioned dynamically allow tracking within field of view; enables a focused very small region of interest for analysis; reduces the size of data to be analysed; enables a fast thin neural network for the vision system to be established.

In one embodiment wherein in calibration mode the region of interest can be overridden/configured manually; identifies the field of view of the camera, identifies the required field of view; permits alignment of the camera to the correct field of view.

In one embodiment the cognition layer captures knowledge captured from the video frames used in the multi-factor confirmation that have passed the confidence index; frames that capture new, better or alternative execution of the process are collated and fed back into the neural network; the neural network is retrained.

### BRIEF DESCRIPTION OF THE DRAWINGS

The invention will be more clearly understood from the following description of an embodiment thereof, given by way of example only, with reference to the accompanying drawings, in which:

FIG. 1 is a block diagram which shows an Open Loop Manufacturing Execution System;

FIG. 2 is a block diagram which shows a Closed Loop Manufacturing Execution System;

FIG. 3 is a block diagram which shows the System Architecture from the user conceptual level;

FIG. 4 is a block diagram which shows the System Architecture from development perspective: software high level classes;

FIG. 5 is a schematic diagram which shows the IT Architecture;

FIG. 6 is a schematic diagram which shows the Physical Hardware;

FIG. 7 is a block diagram which shows how the modules interact with the confirmation that the step is complete;

FIG. 8 is a schematic diagram which shows the Intelligent Queueing system used to capture the video record;

FIG. 9 is a schematic diagram which shows how different forms of media are uploaded to the front end to be received by a human as instructions based on their preferences.

FIG. 10 is a block diagram which shows the System Architecture Class Diagram;

FIG. 11 is a Data Flow Diagram for a system in accordance with one embodiment the present invention;

FIG. 12 is a flow diagram which shows the sub-process for a user;

FIG. 13 is a flow diagram which shows the method for multiple user log on for load balancing;

FIG. 14 is a flow diagram which shows the method of Image Generation which feeds a dataset to the neural network to produce a Thin Neural Network Model;

FIG. 15 is a flow diagram which shows the how Image Generation Data Augmentation Algorithm produces a large training set from a single image;

FIG. 16 is a schematic diagram which shows multi-factor confirmation via multiple neural net models;

FIG. 17 is a schematic diagram which shows the system locating and establishing a datum in order to locate future AI Models;

FIG. 18 is a schematic diagram which shows the human override the region of interest; and

FIG. 19 is a flow diagram which shows a self-trained Neural Network capturing image which have passed a confidence threshold and using these images to self-train future iterations of the neural network.

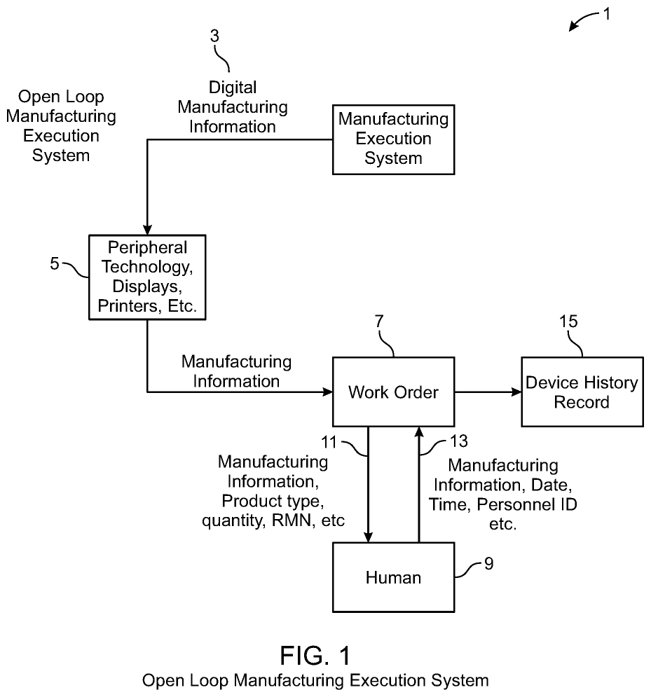

### DETAILED DESCRIPTION OF THE DRAWINGS

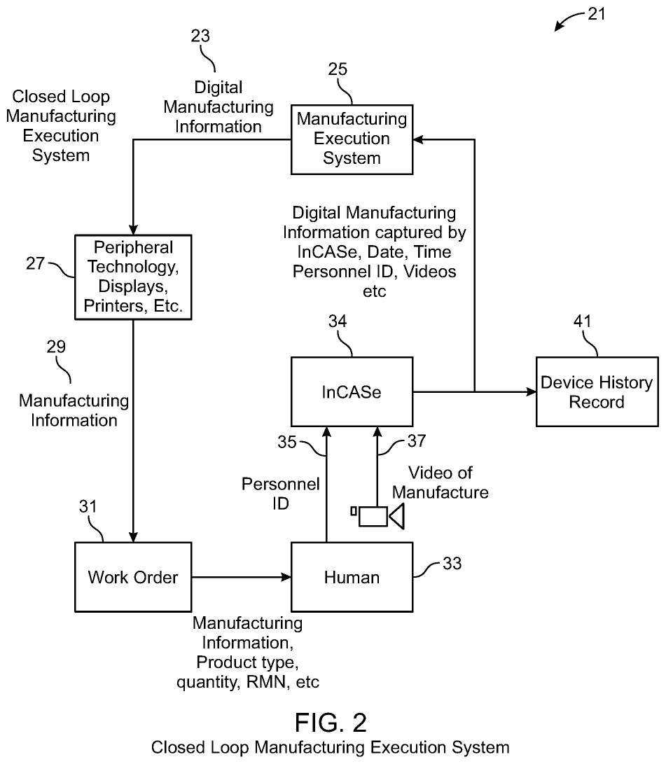

Features of the present invention will be set out in general terms and also with reference to FIGS. 2 to 19 below.

The present invention provides a system which unobtrusively monitors the user at work and uses machine learning to identify if that user needs support and if so, offers that support. The system is configured to read the user's preferences and to provide feedback in real time to that user, thus enabling new interactions and co-operation between users, the work environment and products in a quality driven lean and agile production system. Thus, the user is within the loop, supported by technology and artificially intelligent driven assistance systems.

The present invention provides a user-cyber-physical interface to the MES systems, thus enabling a closed-loop MES. It actively collects production information to be returned to MES, without any input from users either digitally, or via a hardcopy which would need to be stored.

In at least one example, the system has an AI Driven Vision System, dynamic user instructions and detailed quality records that work to close the loop between open MES system and users, while improving the integrity of production.

In at least one example of the present invention, the AI Module uses a StepBuilder object to create the process and steps from the information in the database. The AI Module iterates through the steps of the process while looping each step until it is complete. Each step monitored by the AI Module has multiple classifiers, such as the AI model or models to be used, the vision sensor or sensors to be used and the relative region of interest (ROI) for the corresponding models.

The AI-driven vision system uses one or more models, captured by one or more sensor streams to determine whether the confidence threshold has been successfully crossed, thus assessing that the step has been completed. This provides a signal throughout the system to confirm that a user has completed a step of the manufacturing process correctly, thus confirming that the work instruction for the product has been followed correctly.

The AI Driven Vision System layer is a primary part of the cognition layer. Multiple thin neural networks are used to observe the object from a multiplicity of viewpoints. These thin neural networks comprised of a fraction of the number of layers normally existing in a deep neural network. Being a thin neural network, they can be built relatively quickly when compared with a deep neural network which fits with the scalability requirements across multiple product lines and the responsiveness required for a batch-of-one. Training data for the thin neural networks can be automatically populated using a data augmentation algorithm. The thin neural networks can be future augmented with a labelled dataset of data that previously passes the confidence index threshold thus meeting the requirements of supervised learning AI.

The step-complete signal is used to capture a video of a production step, capturing frames before and after the signal was received using an intelligent queueing system. This means only the information most critical to production is captured rather than the whole process. Videos can be saved at varying frame rates and resolutions ensuring more critical steps are captured in higher detail. Thus, minimisation of the quantity of data to be captured is achieved. This is achieved by temporarily pushing one or more video frames of the implemented steps in a data queue, on receipt of a signal that assembly is complete, save a specified number of configurable frames in a digital/video record, overlap contextual data on the video frames, and save as a least one or more assembly records.

Upon receiving the step completion signal the intelligent queuing system retains a number of video frames in the queue immediately prior to the signal being received. An equal number of video frames are added after the signal has been received. The queue now holds a number of video frames before a signal was received in the first half of the queue, and an equal number of video frames after the signal was received in the second half of the queue, thus providing a before and after record.

This video is then stored with information typically input by a user, for example, the date, time, the user identifier, the raw materials used, the batch produced, and so forth. Similarly, process parameters which are typically undocumented can be acquired from varying sensor streams and saved with the video record, ensuring production standards are upheld.

A user can then search a database to find the production information for a specific product. The user can search by date, time, the user ID, the unit ID, the work order, confidence index, process variables such as temperature, pressure etc, steps flagged for a quality check or a combination of the above. This returns videos and/or other data documenting the creation of the product. Videos can be watched or downloaded by the user. Data can be exported for data analysis.

The system is capable of tracking the steps which the user has carried out through the AI vision system and it is capable of offering clear, concise instructions visually through video or written instructions, or aurally through spoken instructions.

The User Instruction Module loads associated instructional text, video and audio files from a media folder/server that relates to a process and selects components to use according to user preference, as well as selecting languages for audio and text according to user preference.

By using the confirmation signal from the AI module, it determines when to progress and display instructions through a dynamically loading webpage that requires no user interaction to progress or change. When a user completes a step, this is confirmed to them via visual signalling from a traffic light, as well as by a confirmation noise which acts upon hearing as a pre-attentive attribute. The pre-attentive signals to the human provide confirmatory positive feedback that does not require conscious effort thus not interfering with the speed and flow of production.

The above elements of the system are controlled by the Cognition layer, which monitors and loads the intelligence and the product line information, running the code for each stage of the process. This cognition layer makes use of multi-threading so as to perform the analysis in real time.

The system also performs quality checking and compliance in real-time. So, in addition to the documentation record, a video record of the part being produced is also available to the MES. This rich data source permits engineers to review where any issues occurred, or conversely have proof that a part was correct manufactured as it left the production floor.

The creation of the video record, and the ability to track that products are complete at a unit level allows the system to give feedback to the Manufacturing Execution System from which the work orders are being generated. This enables the return of manufacturing information, as well as flags to notify that a unit has been completed. As such, this closes the feedback loop to the manufacturing execution system, creating a digital record with all information relating to the unit's production.

This invention addresses the issues in manufacturing environments, the first of these is the issue of traceability. Due to their nature, these environments often lack the uniformity on which industrial traceability relies. Parts are often in unpredictable orientations and due to the high levels of human interaction, processes are rarely carried out in the same precise locations, making it incredibly difficult to track a unit throughout its production process. Another issue is providing effective operator support.

This solution vastly increases product traceability as it captures the production process of each individual part and contextualises the data immediately. In conjunction with robust product tracking, this greatly increases the level of product traceability which can be achieved in manufacturing environments.

The second issue this invention addresses is digitalising manufacturing environments in order to establish an effective digital record of both the process and the product. This is an incredibly difficult task to overcome, as non-automated manufacturing environments generally lack the same level of system integration as their automated counterparts. As such, it becomes incredibly difficult to provide cognitive support to the user or a human that allows human-in-the-loop. The invention rather than attempting to monitor the human for reporting to others, assists the human by providing the intelligence to the human empowering them to use that to find production instructions, notify them of errors in real time providing the opportunity to fix, provide confirmatory support during the execution of their work, so that ownership is with the human.

The final issue which this solution addresses is data collection in manufacturing environments. Due to the low level of sensor and actuator integration, a large quantity of data is recorded in hard copies which must then be stored for the product's life cycle. This produces a vast amount of paperwork for a single lot, as there is a high quantity of related paperwork for each individual unit. As such lot sizes must remain quite large to ensure that this paperwork is manageable, and production is efficient. Issues also arise when a unit is re-called as the entire associated lot must be returned. This is a particularly prominent issue in the Medical Device Industry, most problematic with Grade III Intravenous devices as they are often implanted and in operation.

The power of this solution is its ability to collect and contextualise the data related to a particular unit. Process data can then be tied to the unit and automatically exported to a database, reducing the necessity for hard copies and in turn the necessity for lot related paperwork. This allowing non-automated manufacturing environments to reduce their lot size, enabling them to better approach the Industry 4.0 standard of Lot Size 1.

In addition, the digitalization of manufacturing is generating huge volumes of data that are difficult to store, process and analyze. Due to the minimization techniques designed for creating of the digital record, and the use of thin neural networks the data produced herein is close to its intrinsic dimension.

FIG. 2 depicts an example of a closed loop manufacturing execution system 21 in accordance with the present invention. Digital Manufacturing information 23 uses data transfer protocols to receive production instructions from an external production lifecycle manufacturing systems and a manufacturing execution systems 25. The information is sent to peripheral technologies 27 such as printers or displays for a user to interpret form a hardcopy or softcopy work order 31. The work order 31 contains the necessary manufacturing information 29 for the human user (the user) 33 to complete a product, such as raw materials to be used and the quantity of product to be produced. Through a user sign on, as well as an Artificial Intelligence vision system, the user's unique identifier 35, the date, time, the unit's unique identifier or other information depending on the complexity of the system, is actively captured by the system 39.

The artificial intelligence vision system triggers the capturing of a video 37 of each step of the manufacturing process with which the manufacturing information is stored 41. This manufacturing information, with flags confirming the completion of each step of the manufacturing process for each individual product in the work order, is returned automatically to the Manufacturing Execution System production process external systems automatically without the need for user input, thus closing the loop to the Manufacturing Execution System.

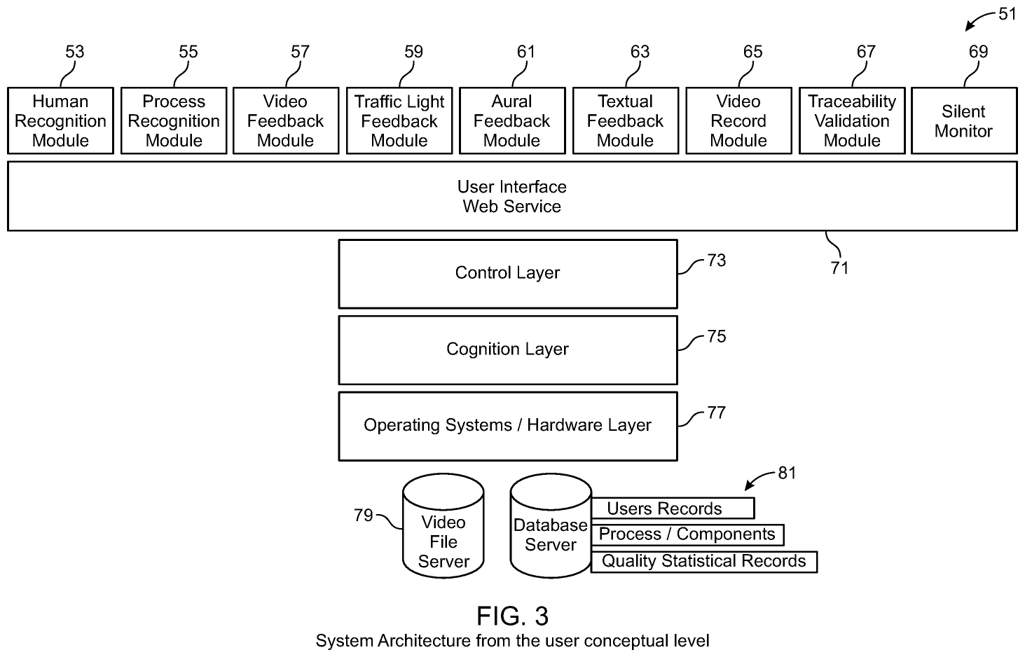

In FIG. 3, the System Architecture 51 from the user conceptual level is illustrated. A user is presented with the “Human Recognition Module” 53. This module recognises the user via a multiplicity of login choices on a staff identification card by use of a barcode reader, Radio-frequency identification (RFID) scanner, Near-field communication (NFC), vision system recognition or any other alternate means. The login attempt is authenticated, and the user is permitted access to the system. Users of different work roles are presented with different and applicable options, for example an user/manufacturing team member will be presented with the instructions for the products on which they are trained, a quality engineer will be presented with options to search and retrieve past work records, and the configuration engineer will be presented with options to set-up new processes, and so forth.

The “Process Recognition Module” 55 verifies a work order by accepting the input of the work order/process job number and retrieving the appropriate instructions.

It performs checks to ensure that the requested job can be performed at that workstation/location. The “Video Feedback Module” 57 loads the instructions to complete the next step in the production process, where each production process is dissected into a discrete number of steps with go/no-go conditions identified at the end of each step. The video instructions continue to play in a loop until it receives a step-complete-signal, when the next video instruction is loaded thereby providing real-time instructions on each step, and confirmation that the step is complete by progression. Thus, the user receives the right instructions at the right time, in the right place, within the right context.

The “Traffic Light Feedback Module” 59 displays a subtle green light for positive feedback where the step-complete-signal has been received. Amber lights can be display when a tolerance is within range. Red light feedback indicates that the step has been completed incorrectly and must be undone or discarded. The “Aural Feedback Module” 61 sends aural instructions to the user as to the work to be done in the next step. These aural instructions are available in the user's chosen language. Aural feedback is also provided to the user as an audible click and acts as a pre-attentive attribute, capturing the attention of user to ensure they receive feedback on their actions. The “Textual Feedback Module” 63 displays text instructions on the monitor as to the work to be done in the next step. These textual instructions are available in the user's chosen language. The “Silent Monitor” or silent partner 69 monitors the steps being completed and provides no instructions or feedback for use by an experienced user.

However, if the cognition layer notices that the step is not being completed correctly, then it can intervene and prompt the user as to the correct step, or with an instruction that the step complete does not meet the satisfying conditions providing the user with the opportunity to correct that step at that point in time. The “Video Record Module” 65 records a video of the step-complete, so that a live record is taken on the production at each stage in the production process. The video record is taken for a specified number of seconds before and after the step-complete-signal is received, thus the record illustrates what happened just before and just after the critical moment, thus goal posting the step. The frame-length and the quality in frames-per-second are configurable thus one frame (i.e. one image) or multiple seconds could be taken. Other data relevant to that step being completed are also captured with the video.

Whether to record a particular step, and whether that step is critical to quality (CTQ) can be specified thus only the relevant parts of the process, as flagged, are stored thus reducing the storage requirements.

The “Traceability Validation Module” 67 provides data analytics, search and retrieval functionality, where approved users can search for data records by process, by work order, by user, by timestamp, by location and other searchable parameters. The “User Interface Layer” 71 provides the services to the users, it receives live data from the front end, which is dynamically loaded, requiring zero-input from the user for progression from one page or service to another. The “Control Layer” 73 is the engine of the system that monitors state and signals, loading appropriate modules and functionality. The “Cognition Layer” 75 is the intelligence layer. It performs the artificial intelligence computations using thin and augmented neural networks as image vision systems. The “Operating Systems/Hardware Layer” 77 captures the physical architecture of the system. The storage layer comprising of video file server 79 and database servers 81 captures the notion that storage is persistent.

A key area where this solution is particularly powerful in is non-automated production environments. A highly intricate manufacturing process can be observed with high levels of data collected. The data can then be stored with and/or overlaid on the video file for immediate data contextualisation. The overlaying of data on the video reduces the high-dimensionality problem associated with big data in the digitalisation of manufacturing so that the record is close to its intrinsic dimension.

This contextualised data is directly tied to a unit and lot in the manufacturing environment. As such, when a unit is recalled, the unit number can be extracted in the field and relayed to the manufacturing company. The manufacturing company can then search through the database of video files, extract the files relevant to that particular unit and perform an in-house quality check. Similarly, the units made directly before and after this unit can be then be inspected to ensure that no issue arose which may compromise the entire lot of units.

While the video file allows for the immediate contextualisation of the data relating to the unit's manufacture, it also serves the purpose of creating a digital record which documents that unit's manufacture. This digital record can be stored for the product's lifecycle and accessed by the manufacturing company as issues arise in the field.

Points of key importance throughout the unit's manufacture can then be highlighted as critical to quality, ensuring these are saved in far greater detail, at higher framerates and greater resolutions. As such, the data that is saved is guaranteed to be critical to the unit's quality and ensures that the data which a manufacturing company is most concerned with is most accessible.

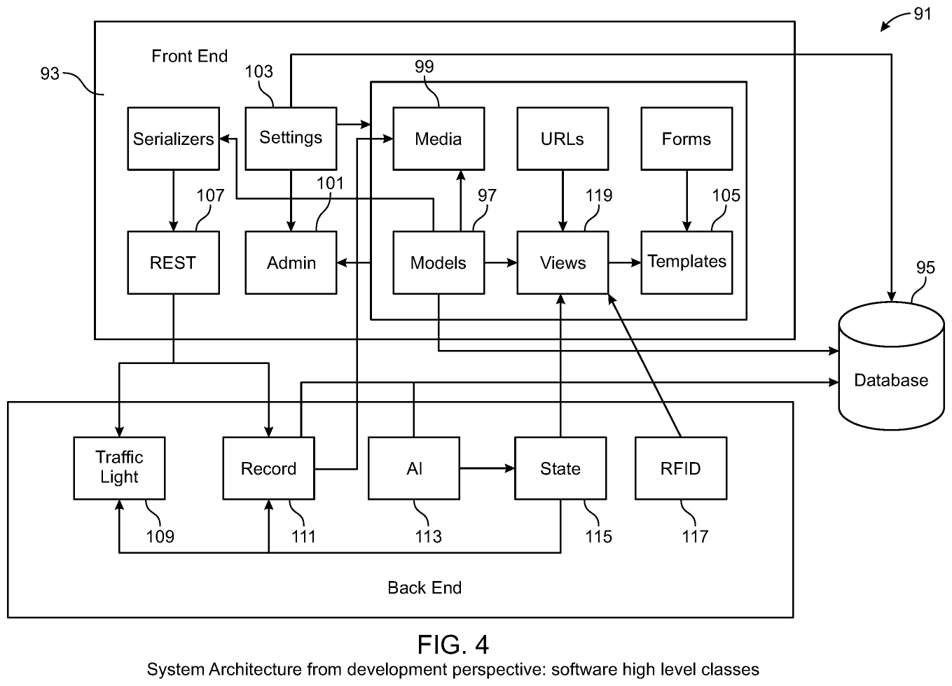

In FIG. 4 is a System Architecture diagram 91 from a low-level development perspective. The user interacts with the system through the front end or front facing side by way of a web architecture-based application accessed through a web browser.

The front-end application is made up of HTML pages that contain design elements driven from a template in which a base standard of design is implemented and reused throughout the application to maintain consistency and familiarity. These templates are filled and delivered by many different views in which the views contain responses used to populate the templates.

These views are a function of the system that receive a web request and returns a web response, supported by the URL's component which contains the information to link the pathways within the system and provide locations of functionality. The views are used to perform operations that fetch low level objects from the database, modify said objects as needed, render forms for input and build HTML among other operations.

The objects fetched from within the views are modelled by the model's component. These models are made up of attributes that relate to the data stored within the database 95 where each attribute represents a database field. A set of attributes makes a model. A model may represent a profile of a user, the user itself, a neural network model, a step within the instruction module or a record from the record module. Some models contain within them reference to files and folders stored as part of the instruction module by way of media files 99 such as video, audio and text. These media files are allocated storage and retrieved by the media component.

An admin component 101 acts as an overseer that can modify the components on a lower level to a standard user. A group of settings 103 are applied that dictate the framework configurations which include the base directory, the allowed hosts of the application, the installed applications, the middleware, the templates directory backend 105 and options as well as the database interface, password validators, overall language, time zone and the static content and media URLs, their directories and roots. Information from the models 97 and database driven components are serialised in a JSON format to be broadcast out via a Representational State Transfer (REST) communication architecture.

The communication architecture talks to the backend component of the system which retrieves information about who is using the system and how they are using it, for example what preferences the user has in terms of what high level components they wish to be able to use. The traffic light module 109 uses this information to understand when to function or not. The record system 111 uses this information to build the record, both within the video file itself as overlaid text and the record as a whole. The state component is driven by the AI module 113 which dictates the step complete signal status 115. This in turn informs the traffic light module 109 and the record module 111 on when to perform their respective timing actions. The AI module 113 retrieves information from the database on how to build its models and in turn classify those models. The RFID module 117 is used to inform the front end views 119 on who has logged on to the system and their corresponding level of authorisation.

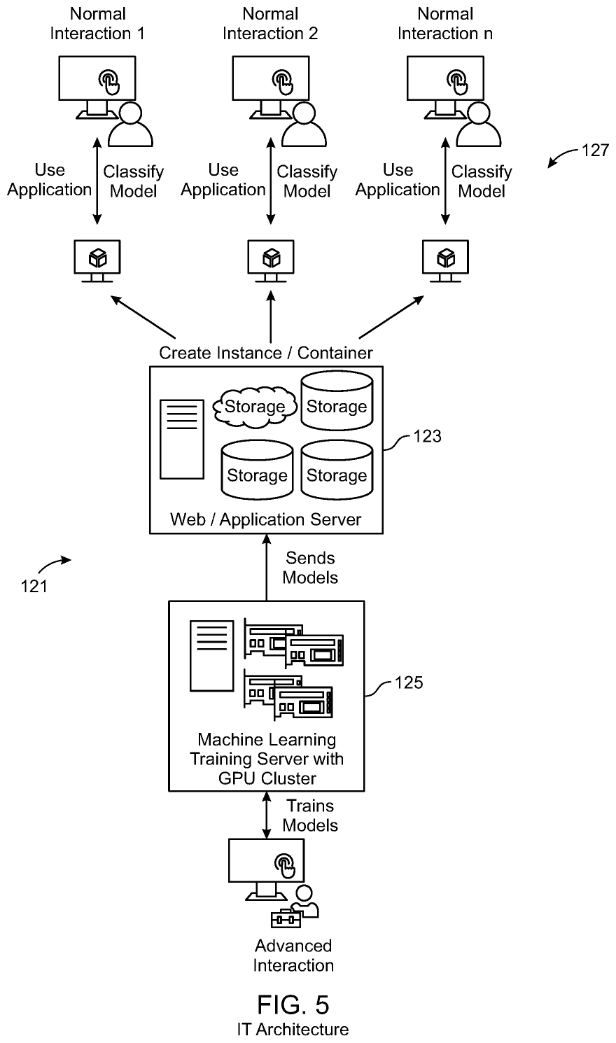

FIG. 5 shows an IT Architecture method based around a web/application server 123 and a machine learning training server 125 connected to users 127. The web /application server hosts the web service and application that the users interact with and this is virtualised to create individual instances of the service to each user on a given workstation or line. It is backed up with storage in the form of database, both locally and remotely in the cloud. The web/application server receives generated neural network models from the machine learning training server 125. The machine learning training server contains within it a set of high-powered computer graphics cards connected in parallel to process the neural network models efficiently and with reduced training times, accessed outside the normal system interaction. The architecture may use cloud-based services, fog-computing, edge-computing, networked-computing, or local-computing. The system uses multi-threading to maximize utilisation of computing resources.

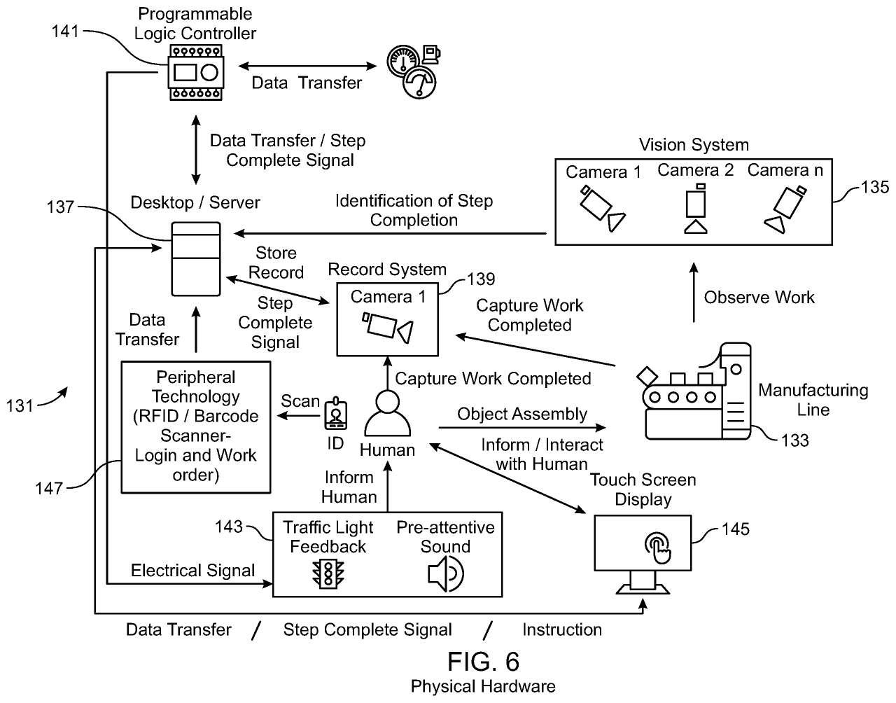

FIG. 6 shows the Physical Hardware 131 and the connections between them. The manufacturing line 133 is observed at distance by a set of cameras 135 used within the vision system. These cameras 135 are connected to a desktop computer or server 137 through universal serial bus (USB3) high speed cables through USB ports, or some connection. These USB ports are assigned and handled through the use of the serial numbers associated with the cameras. Similarly, the Record System Camera 139 is connected through a USB port and accessed instead by the Record module that not only observes the manufacturing line but also captures it and stores the information. With the identification of the completed step the desktop or server communicates with a programmable logic controller (PLC) 141 over an ethernet connection which in turn switches on or off the traffic light LEDs with a pre-attentive click sound. The touch screen monitors 145, RFID scanners, barcode scanners and all other peripherals 147 are connected over the network.

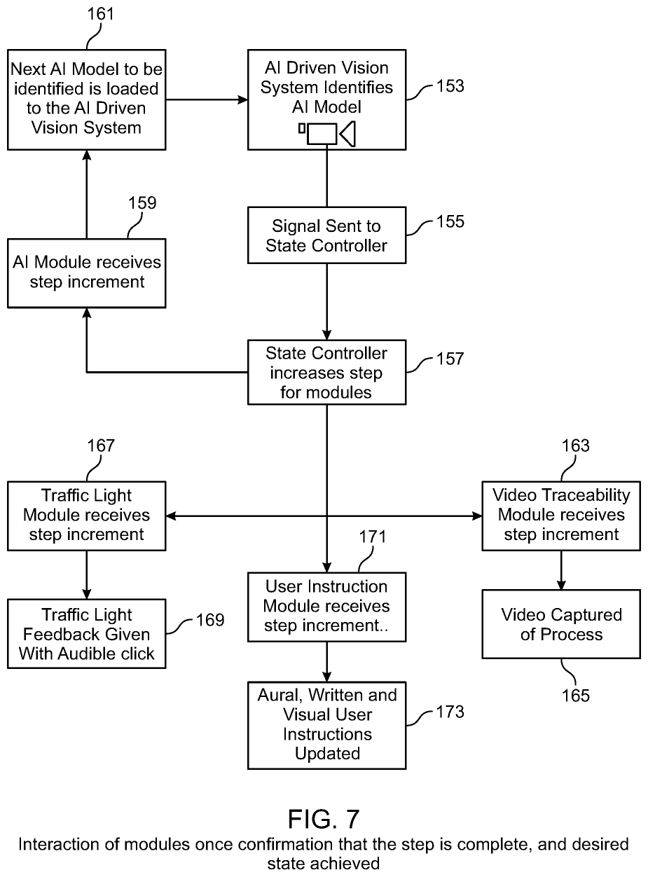

FIG. 7 is an interpretation of a flow diagram 151 which shows how the modules interact with the confirmation that the step is complete. The AI-driven vision system is used to identify one or more AI models from one or more vision sensors streams 153. Upon confirmation that the AI models representing the step of the manufacturing process are present, the step is considered complete. The state controller then increments the step for all modules 155,157. The AI Module loads in the one or more models 159, 161, and one or more cameras for the following step.

At step 157, the video traceability module captures a video of the process to be stored with manufacturing information 163, 165. The traffic light module offers visual and audible feedback to the user to confirm the step is complete 167, 169. The User Instruction Module loads in the aural, written and visual user instructions in the appropriate languages based on User Preferences 171, 173.

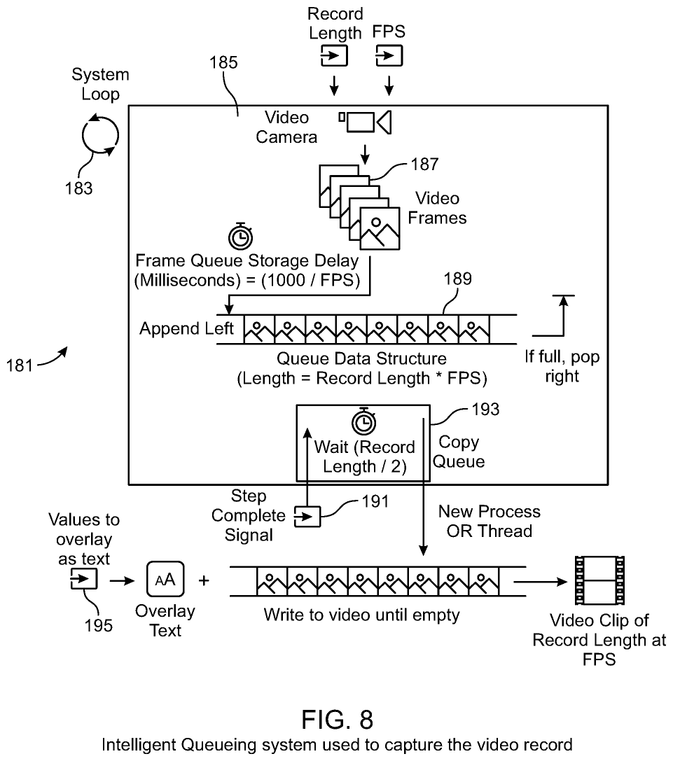

FIG. 8 shows the Intelligent Queueing system 181 used to capture the video record. A queue length and a frame rate is provided on configuration. The queue length and frame rate can be adjusted accordingly based on the event which is being monitored.

A video camera is pointed to an area of interest and captures live video frames constantly. These video frames are passed through a queue-based data structure on a roll in roll out system, commonly referred to in computing as first in, first out. These frames are discarded by popping off the top of queue.

The process listens for a signal to indicate an event of interest has occurred, such as may be generated by an AI-driven vision system or an IoT sensor. This event of interest is recorded. On receipt of the signal, a number of video frames in the queue immediately prior to the signal are retained, with unnecessary frames being popped off the queue. An equal number of video frames are added to the back of the queue after the signal has been received. The queue now holds X number of video frames before a signal was received in the first half of the queue, and an equal number of video frames after the signal was received in the second half of the queue, thus providing a before and after record.

As shown in FIG. 8, acting within a system loop 183, a live camera 185 feed is broken down frame by frame 187 and stored in a dynamic queue 189 at a constant rate dictated by frames per second (FPS) value, inputted by a user. This value dictates the visual fidelity of the completed video. The size of this queue is configured based on a user input record length. The size directly relates to the desired timeline of any processed record. When a step complete signal 191 is received the module waits for a period of time 193 allocated at half the record input length and then immediately creates a copy of the live queue for processing. External data values 195 that represent important step information such as the user ID and work details are then overlaid onto each frame of the video before the full copied queue is written frame by frame into an assembled video 197 at the original input FPS and length. This provides a view into important visual events equally preceding and succeeding the moment in which a step is understood as complete while discarding non-important information, reducing data storage and analysis requirements.

Traditionally, data can be stored in two types of queues: ‘First in, First out’ and ‘Last In, First out’. These are more commonly known as FIFO and LIFO respectively. An issue arises when a signal is received by a system using these data queuing techniques. The system may only capture data either before the event occurs, or after, but not both. This results in an inability to fully capture and contextualise all of the data relating to an event or events.

This solution vastly increases data contextualisation as it captures data both before and after an event occurs, this gives a greater, more holistic view of an event. As such, this data queueing method solves an issue created by LIFO and FIFO queues, as they are unable to fully capture an event.

This solution also allows for a reduction in the quantity of data necessary to capture when contextualising a process. The alternative approach to using the FIFO or LIFO queues was to record everything. So in a manufacturing context a video record may store a full record of what happened over a working day at a particular location. This causes significant issues in storage requirements and the effort required to post-process or post-review that video record. In this invention, a much shorter video record is taken which is recorded on receipt of a signal. Typically, this signal will be generated by a machine learning algorithm (e.g. a vision system based on a neural net indicates that the operator has performed their task correctly) or a sensor (e.g. spike in temperature, breakdown, fire etc.). On receipt of this signal a video record is taken that captures x number of seconds before the signal, and an equal number of frames after the signal. Thus a great reduction can be achieved in the quantity of data needed to be processed and stored.

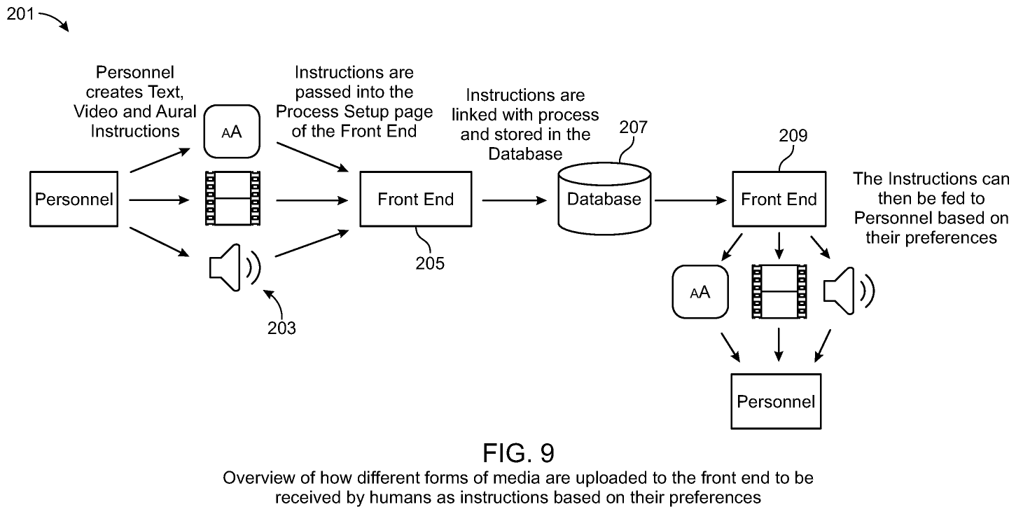

FIG. 9 is a schematic diagram 201 that depicts how different forms of media are uploaded to the front end 205 to be received by a user as instructions based on their preferences is illustrated and stored in a database 207. Training material is input 203 through a number of different media via the system front end. This aural, visual or textual instruction is taken by the system and linked to the corresponding process and step. Based on the preferences of the user using the system, this material is given to them via the front end 209. Audio, textual and visual instructions are available in to the user and can be turned on or off, allowing for a combination of instructions selected by each individual user using the system.

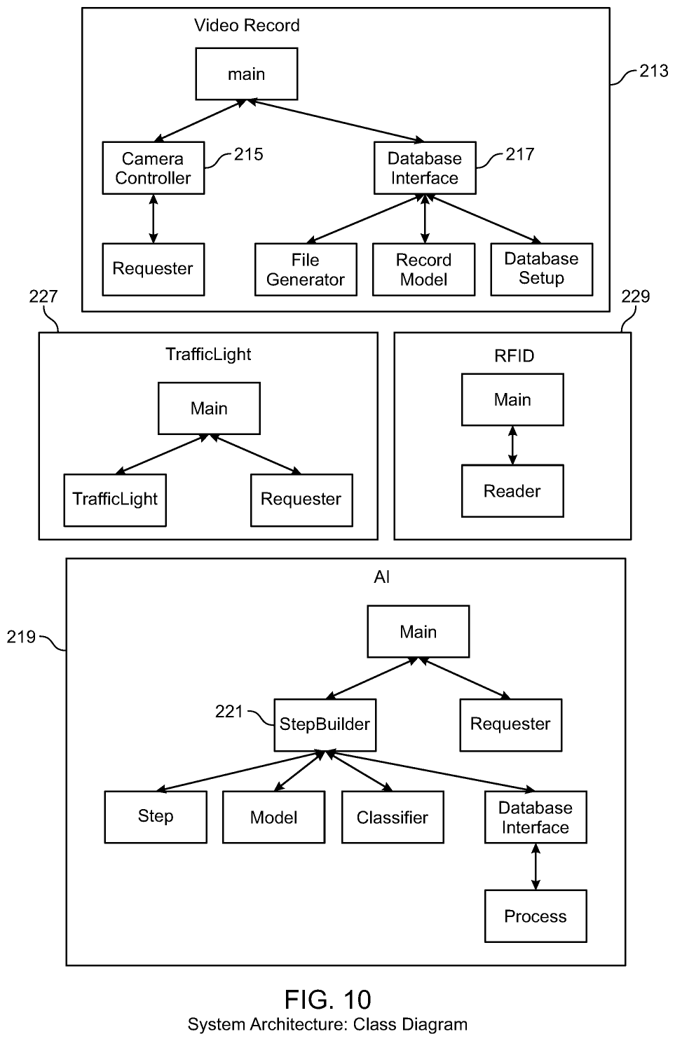

FIG. 10 is an interpretation of the System Architecture Class Diagram 211. It represents the low-level configuration of the backend system and relationships between classes that act as a template for the programming objects that the system uses to enable functionality and perform operations. They are based around the use of object orientated programming in which all classes contain both behaviour and data attributes. As they are of the microservice architecture they each individually run off their own respective main functions.

The record module mainly provides functionality through the class CameraController 215, where camera operations are performed, and the DatabaseInterface class 217, where database commands and interactions are performed.

The AI 219 is supported by a StepBuilder class 221 that assembles the neural network pre-processed models for use and classification and a Database interface class that retrieves information about a given process.

The TrafficLight module 227 connects via USB to inform decisions on when to operate through the front end. The AI, Record and TrafficLight modules are deeply embedded in the use and configuration of the step completed signal to function. The RFID module has a reader.

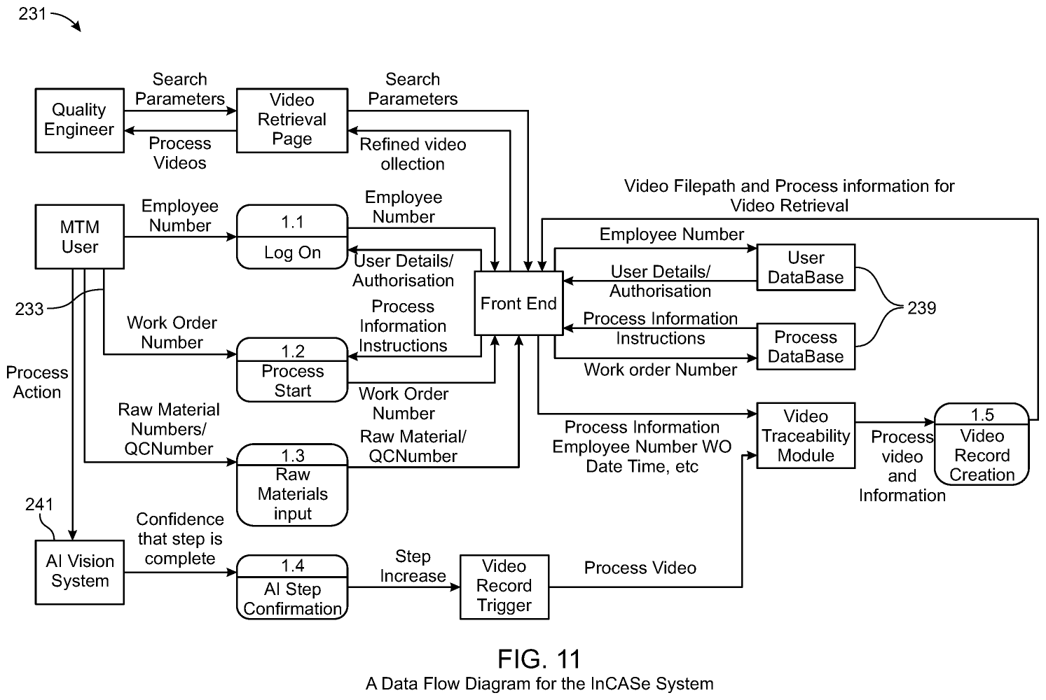

FIG. 11 shows an interpretation of the Data Flow Diagram 231 for the system and captures one example of how the data may flow within the system. An employee logs on 235 and, based on the work order entered 233, the system collects information from individual databases 239, including external MES/PLM or other systems. This information is relating to the completion of the product. The user may enter the raw materials to be used 237, or these may be harvested automatically by the system depending on the complexity of accompanying manufacturing systems. Once the user begins the manufacture of the product, the AI driven vision system 241 begins to gather manufacturing information, capturing when the step is complete and recording the manufacturing process. This is then captured with other manufacturing information. When a user with a higher access level enters the system, they may search for these videos by accessing the front end. By input of the manufacturing information available to them, thus allowing them to identify the video required.

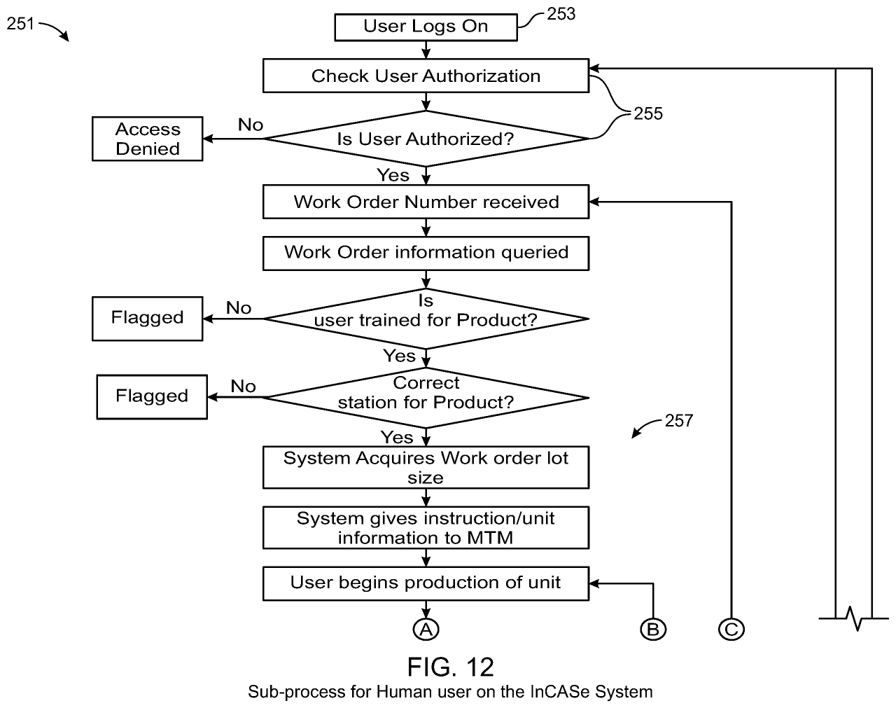

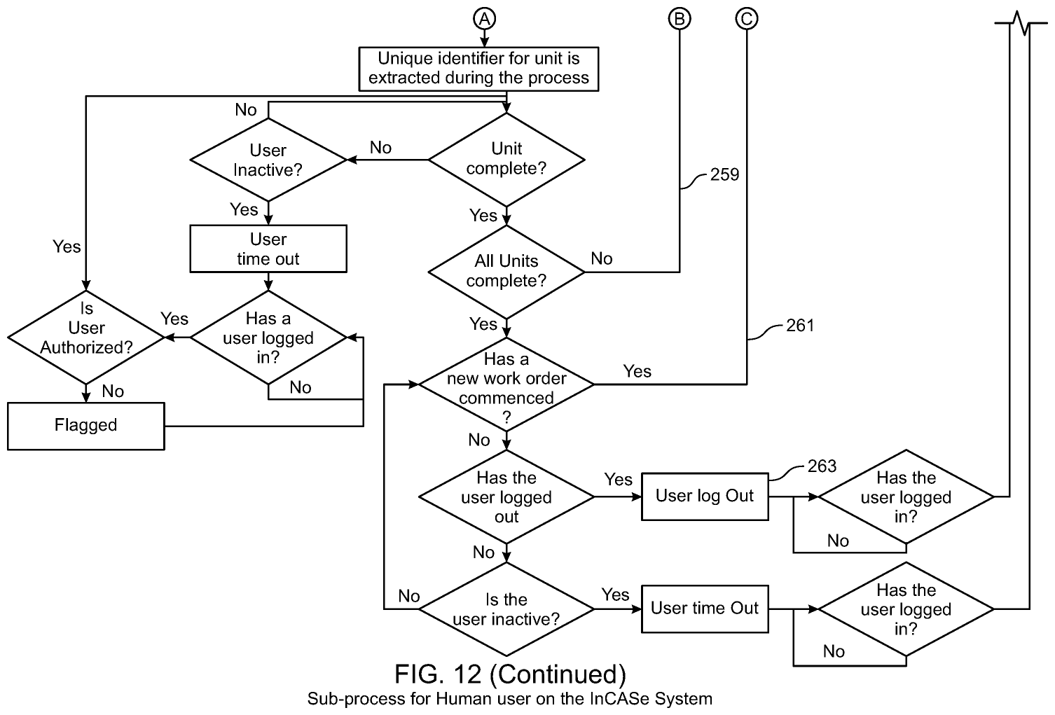

FIG. 12 shows the sub-process 251 for a User using the system to manufacture a product. As the user logs on 253, their authorization is checked 255 to ensure they may use the system, as well as checking if their training is up to date for the product they wish to complete. The system acquires information relating to the manufacture of the product from the databases highlighted in FIG. 17.

The work instruction for the product to be manufactured is relayed to the user 257 based on their preferences. As the user carries out the manufacturing process 259 the unique identifier for the unit is extracted if available. The user will then work to complete the product. The system monitors the work order until all units in the work order are completed and as such the work order is deemed complete 261. During this manufacture the system extracts the manufacturing information as well as videos of the manufacturing process when each step of the process is completed for each unit in the work order. The system monitors for as long as a user is manufacturing a work order. For periods of inactivity, the user can be logged out 263. In this event, or in the event the user logs out the following user to log into the system will continue on the step that the prior user logged out of the system. The system can as such track multiple users completing single units.

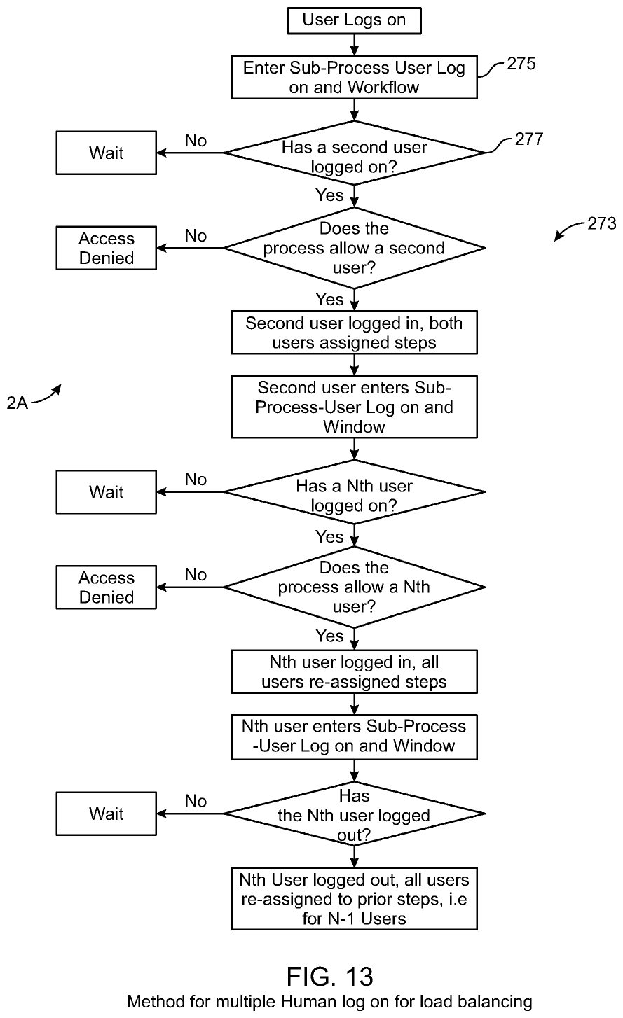

FIG. 13 is a flow chart 271 which illustrates how a production process may be distributed between multiple user actors, operating concurrently for load balancing. The system tracks multiple users who may be completing the manufacturing of a product. When establishing a process, a user will enter the number of potential users to be manufacturing the product as well as how the steps required to complete the product are divided between the users.

When a single user logs on to the system 275, they can work on all of the steps to complete the product. When a second user logs on 277, they are automatically assigned steps of the manufacturing process to complete based on how the steps of the manufacturing process were divided when the process was established for a second user. If the process was not established to allow for a second user, they will not be logged on until the first user logs off. The same applies for the Nth user, so long as the process has been established to be worked on by that number of users, the process will automatically assign the steps of the manufacturing process to that number of users, based on how it was originally established. If the process has not been established to allow the Nth user to work on the product, they will not be logged on to the system.

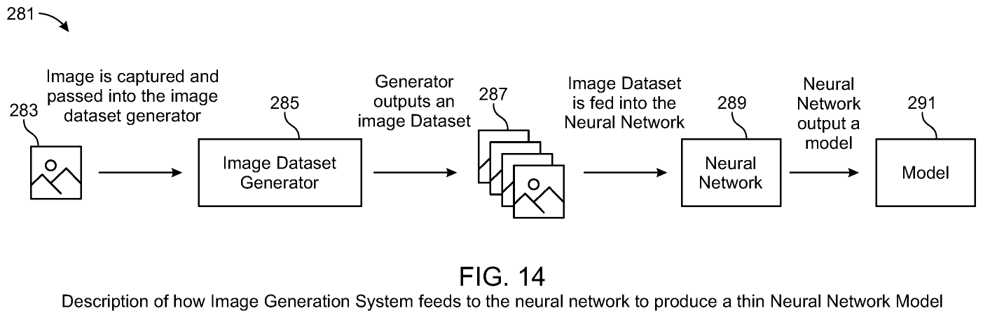

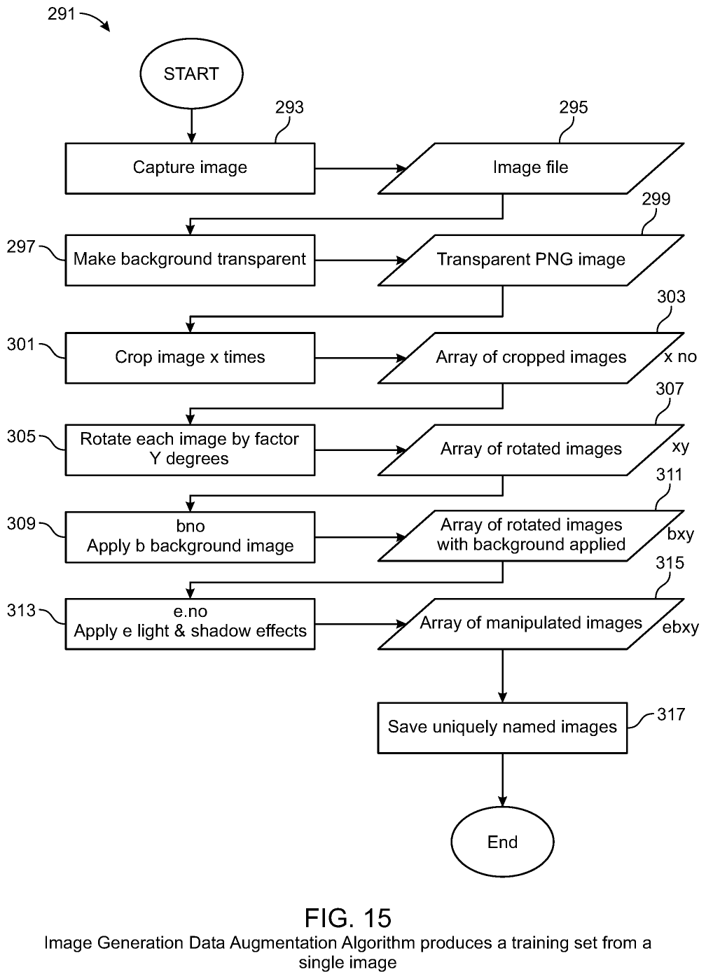

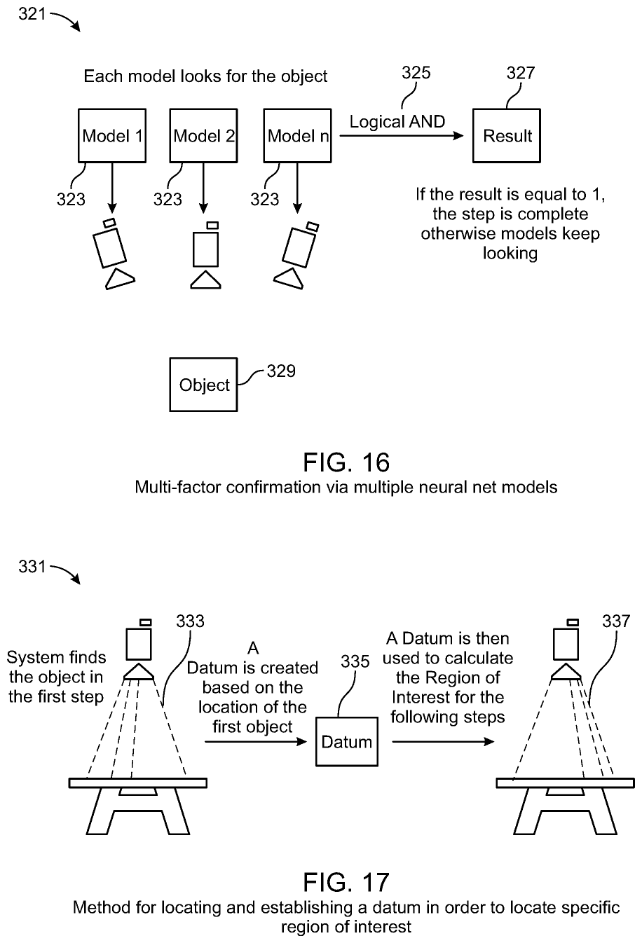

FIG. 14 is a schematic diagram which shows the Image Generation system feeding a dataset to the neural network to produce a Model. A single image is captured by the system or a user. This image may be handed to the Image Generation Data Augmentation Algorithm (see FIG. 15) for processing to create a training image dataset suitable for deep networks, or alternatively may be used to create a thin neural net. The output is an image dataset generated within a folder by the algorithm. This image dataset contains locally similar images to the input image and the image size has been normalized to reduce issues when training. The image dataset is then used as the input data for training a Thin Neural Network. Once trained, the Thin Neural Network outputs a Model file 291 containing the feature data that was pulled from the image dataset. This Model file 291 can be used to classify images. These Thin Neural Networks have three, or any small number, convolutional layers paired with pooling layers, whereas deep networks often have between thirty and seventy layers, thus training time for Thin Neural Networks is significantly reduced. Multiple Thin Neural Networks can be used in parallel as described in FIG. 16.

FIG. 15 is a flow diagram 291 which shows how the Image Generation Data Augmentation Algorithm produces a training set from a single image. A single image is captured by the system or a user 293. This image 295 is then loaded into program memory and undergoes a series of alterations without consuming the original image. The first of these is to remove the background of the image by making it transparent 297. This allows the picture to focus on the object and remove reliance on the background of the scene. The image containing the object with transparent background 299 is then cropped and re-scaled x number of times to create an array of cropped images 303. This enables a model to be trained to account for the scale of the object it is looking for, meaning the model can be detected at a greater range of distances to the camera. Also, the camera can identify the object if not all of the object is within the frame, i.e. a portion of the object missing out of frame. Each of the cropped images is then rotated 305 at a number of increments of degrees between 0° and 360° to create an array of rotated images 307. The increment is defined by a user.

This will allow the vision system to correctly identify the object from many different angles, meaning that the trained model is now rotation invariant. A number of background images are then added in order to represent the object being viewed in different scenes. These background scenes represent the likely scenes in which the object may be viewed—for example a person may be positioned on a road, at a desk or in a landscape. An array of rotated background images 311 is created. A manufacturing component might be positioned on a workbench which was coloured black, stainless steel, white, or grey background. A number of light effects 313 are then added to the images and an array created 315. These may include contrast or pixel intensity. This allows for the creation of a model which is able to account for changes in the lumens of the environment which it is testing for the presence of the trained model. These images are then saved 317 and added to a collective data set, which can be used to train a machine learning model. Any number of variant images can be generated and added to the data set, allowing for the creation of a more robust model.

This feature of the present invention is further illustrated by the following worked example.

Given the following values:—
1 image taken by the camera attached to computer i->1 image
Image cropped x=20 x->20 images
Image rotated at y=10° xy->20*(360/10)=720 images
backgrounds, b, applied—black, stainless steel,
grey, white, wood bxy->720*5=3,600 images
Apply increasing lumens effects, e, in increments ebxy->3,600*((2180−180)/100)=72,000
of 100 lumens from 180 to 2180 (i.e. the range of
lumens values in workplace lighting regulations)

In this case, one image became a training data set of 72,000 individually named images.

The method of FIG. 15 addresses issues which arise during the training of neural networks, particularly those dependent on image-based data.

The neural networks must be trained with a wide variety of data in order to create a robust, reliable and accurate model. Issues arise in the collection of data to train such a model. The data can either be acquired instantaneously, which results in a smaller data set. Smaller data sets tend to lack reliability, robustness or accuracy, and therefore much more likely to incorrectly identify the item in a vision system. A smaller dataset requires that the item almost exactly matches one of the images used in the training set—same background, same lighting levels, and placed exactly the same position with the camera at the same distance from the item. These conditions are difficult to manage and unlikely to occur in practice.

Alternatively, the data set can be collected with a focus on variety, capturing a greater variance in data. However, in order to capture both a large quantity of data and a large variance in said data, a great deal of human time is required to create each of those scenes and capture and label the images. The time and work requirement necessary to capture such data often leaves the training of models as an unrealistic option, particularly if the model is being captured in an environment which varies wildly.

This method allows the user to automatically create a data set from a single image as well as accounting for data variance, dramatically reducing the time required to collect data for model training while prioritising accuracy and reliability.

FIG. 16 is a schematic diagram 321 which shows multi-factor confirmation via multiple neural net models 323 is illustrated. Utilising multiple neural network-based vision-systems working in parallel, checking individual regions of interest. Those multiple models 323 allow for a multi-dimensional representation of the object of interest 329, so as to achieve multi-factor confirmation. This multi-factor confirmation allows the system to be more certain of when a step has been completed as it no longer relies on a single decision from one model instead, a logical AND 325 is performed on the results 327 of all active models. This means that each active model needs to pass its confidence index threshold for the step to be considered complete.

FIG. 17 is a schematic diagram 331 which shows how the system locates and establishes a datum 335 in order to locate future AI Models. The neural network-based vision system will find the location of the first step within the image 333. This location information will be used as a fixed starting point for which the regions of interest for all subsequent steps will be calculated 337. This will reduce errors caused by the vision system cameras being moved or when tooling/equipment has been displaced.

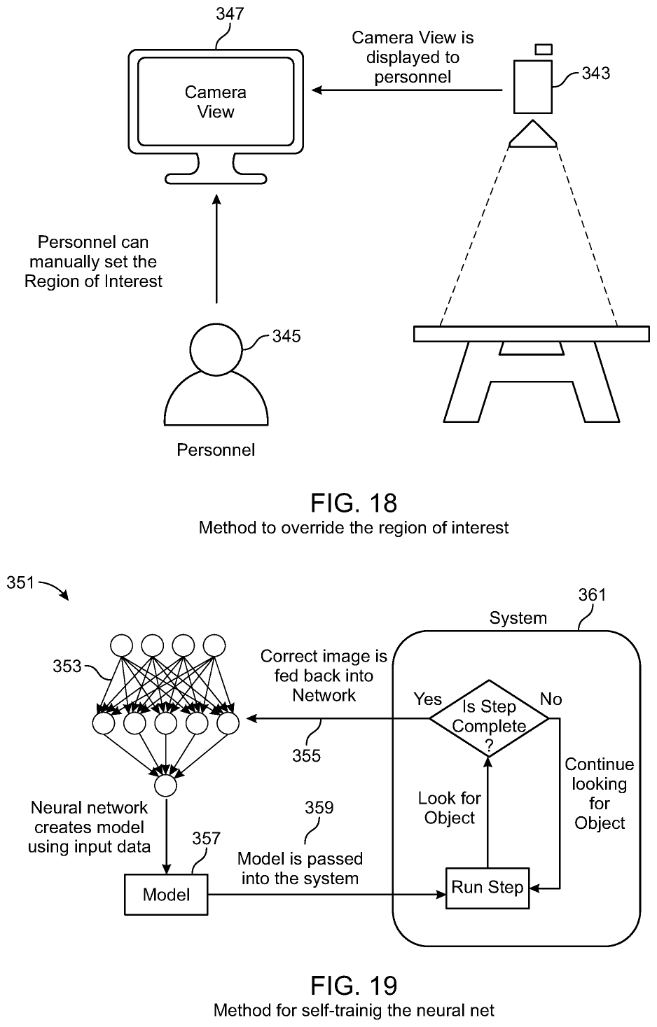

FIG. 18 is a schematic diagram 341 which shows the user override the region of interest. A system for a user to manually configure the region of interest. In a scenario where the vision system cameras 343 or the tooling/equipment used has been drastically moved, the neural network may be unable to automatically set the region of interest using a datum (see FIG. 17). For this reason, a user must have the ability to manually override the region of interest in order to get the system back on track. A user 345 will be able to enter a calibration mode to aid/enable manual changes to the system. While in this calibration mode, the camera view will be displayed on the touch screen monitor 347 alongside an image of the correct camera view. A user will then be able to align the camera so that its view matches the image displaying the correct camera view. Once the camera has been calibrated, the user can exit this calibration mode and continue working as normal. As the camera has been calibrated, the datum will start working again.

In FIG. 19 is a schematic diagram 351 which shows a method of supervised back propagation for training neural networks 353. The self-trained neural network captures images 355 which have passed a confidence threshold and use of these images to create a model 357 which is passed to the system 359 self-train future iterations of the neural network 361. For complex production that falls under compliance with FDA regulations, unsupervised neural network training is not appropriate due to the potential bad outcome. Supervised learning must be employed.

To begin with, the system makes use of thin layer neural nets which require minimum training time, for scalability and to cope with training and communicating requirements for increased customisation of batch of one. A fully trained machine learning layer should have a deeper neural net and in that way can identify nuances in the production process, for example an user might hold the piece differently, or have different sized/coloured hands, or indeed have an alternative approach or workaround to completing the work. When the AI is running, each image is passed through a neural net, and a confidence index calculated. Once the desired confidence index threshold is reached, the AI assumes that the image it is currently looking at satisfies that condition of completing the current step. There will be nuances in each of these images, for example the angle of the object, or plays on light and shadow, or how the object is held or rotated. These nuances capture tacit knowledge and the image taken at that moment in time can be used to retrain the neural net so that new and better, or alternative images can be captured, and a wider generalised deep neural network can be trained.

This system through its use of multiple lightweight thin neural networks based on small region of interests, inference assign to unique processing threads, and data minimization techniques used in capturing digital records, quality records, configurable frame rates and frame quality, and critical to quality selections has the net results that it is lightweight in terms of configuration, set-up, storage, processing, and can be configured for a new process within a fraction of the time required for other production systems.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a memory stick or hard disk. The carrier may be an electrical or optical signal which may be transmitted via an electrical or an optical cable or by radio or other means.

It will be appreciated that in the context of the present invention that the term ‘user’ and ‘human’ are used interchangeably throughout the description and highlight that the invention is used in conjunction with a user or human operator in a non-automated method, system or process.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A production process execution system which comprises:
implementation modules which provide context-specific instructions and intelligence and pre-attentive feedback for implementing the production process;
recording modules which record the implemented steps of the production process by temporarily pushing one or more video frames of the implemented steps in a data queue, on receipt of a signal that assembly is complete, save a specified number of configurable frames in a digital/video record, overlap contextual data on the video frames, and save as a least one or more assembly records;
a control layer which monitors and controls the implementation modules and the recording modules;
a cognition layer which monitors the production process, calculates process quality and provides feedback to a user through the implementation modules as to the correctness of the implemented steps based on the at least one or more assembly records.

2. The system as claimed in claim 1 wherein the cognition layer makes use of thin neural networks to identify one or more representations of the production process, from one or more sensors, to provide feedback.

3. The system as claimed in claim 1 or claim 2 wherein, the feedback comprises a system wide signal confirmation of a step complete state, such that when the step complete state is positive, generate a system wide signal, and push that step complete state signal event to the system.

4. The system as claimed in any preceding claim wherein, the control layer receives instructions on production requirements, human-authentication, location and context-specific information by handling transfer of data from external systems or a system database and provides context-specific instructions to the user.

5. The system as claimed in any preceding claim wherein, the control layer takes a record of the production process and the associated production data at each stage in production process as received from the recording modules.

6. The system as claimed in any preceding claim wherein, data transfer protocols are used to receive production instructions from external production lifecycle manufacturing systems and manufacturing execution systems, or data can be stored locally as a standalone system.

7. The system as claimed in any preceding claim wherein, data transfer protocols are used to send production process completion information to those external systems automatically without the need for user input.

8. The system as claimed in any preceding claim wherein, multi-user concurrent access is provided across a range of manufacturing use-cases.

9. The system as claimed in any preceding claim wherein, cloud-based services, fog-computing, edge-computing, networked-computing, or local-computing.

10. The system as claimed in any preceding claim wherein, the cognition layer uses multi-threading to achieve real-time performance.

11. The system as claimed in any preceding claim wherein, a series of class objects represent the production process, link the trained models, the video, aural and image assets, and any camera configurations to the corresponding sub-step.

12. The system as claimed in any preceding claim wherein, the Cognition Layer makes use of thin neural networks to identify one or more representations of the production process, from one or more sensors, to produce a system wide signal confirming the step complete state.

13. The system as claimed in any preceding claim wherein, the monitoring modules comprise sensors which monitor manufacturing variables including temperature, pressure, tolerances.

14. The system as claimed in claim 13 wherein, the manufacturing variables are captured and overlaid on frames or images then stored as a permanent record of production.

15. The system as claimed in any preceding claim wherein, the monitoring module includes a video monitor which can capture video frames of the user undertaking a task during the production process and store the video frames with a unique job identifier.

16. The system as claimed in any preceding claim wherein, the production process execution system can flag uniquely identified objects to be checked for compliance to quality.

17. The system as claimed in any preceding claim wherein, the monitoring module comprises an artificial intelligence vision system.

18. The system as claimed in claim 17 wherein, a flag can be turned on when the artificial intelligence vision system determines that the user is not working in line with the implemented steps.

19. The system as claimed in any preceding claim wherein, the implementation modules load just-in-time context-specific intelligence, product line information and code executed for each stage of the manufacturing process.

20. The system as claimed in any preceding claim wherein, the implementation modules display context specific instructions as to the next part of production process to the human, through a multiplicity of signals.

21. The system as claimed in any preceding claim wherein, monitoring modules transfer multiple live video stream feeds to the control layer.

22. The system as claimed in claim 21 wherein, the cognition layer recognizes within those video stream feeds a desired state of the object, by comparison to image-based neural networks.

23. The system as claimed in claim 22 wherein, the cognition layer generates a state-achieved signal once a desired step complete state has been achieved.

24. The system as claimed in any preceding claim wherein, feedback is provided to the user through a user interface on receipt of a step-complete signal.

25. The system as claimed in claim 24 wherein, a next steps to be executed are presented to the user on receipt of the step-complete signal.

26. In at least one embodiment of the invention, the production process can be split into sub-stages, so as to allow multiple users to operate concurrently for load balancing.

27. The system as claimed in claim 24 or 25 wherein, receipt of the step-complete signal causes a video record to be taken that of a predetermined time before the signal and a predetermined time after the signal.

28. The system as claimed in claim 27 wherein, the predetermined time before the signal and the predetermined time after the signal have the same length.

29. The system as claimed in claim 27 wherein, the video record is of a configurable quality in frames-per-second, so as to minimize the amount of data to be processed and stored.

30. The system as claimed in any preceding claim wherein, specified critical parts of the process, and those critical to quality can be captured, thus only the relevant parts of the process, as flagged, are stored.

31. The system as claimed in any of claim 1, 12 or 23 wherein, on receipt of the step complete signal, a light is activated to confirm to the human that the step has been completed satisfactorily.

32. The system as claimed in any of claim 1, 12, 23 or 31 wherein, on receipt of the step-complete signal, a relay is activated to produce a sound to confirm to the human that step has been completed satisfactorily.

33. The system as claimed in any preceding claim wherein, the monitoring modules comprise a silent monitor which monitors the user during the execution of their work, and provides assistance to the user if the cognition layer determines that the user needs assistance.

34. The system as claimed in any preceding claim wherein, the cognition layer comprises an image-based thin neural network as a vision system to classify and locate objects.

35. The system as claimed in any preceding claim wherein, the monitoring module comprises multiple neural network vision-systems working in parallel, checking individual regions of interest which allow for a multi-dimensional representation of the object of interest, so as to achieve multi-factor confirmation.

36. The system as claimed in any preceding claim wherein, wherein the monitoring module comprises thin neural networks which identify the location of an object and establish a datum such that future regions of interest are then established from this datum for the location of future models, reducing the impact of changes to equipment set ups, and potential moving of the vision system.

37. The system as claimed in any preceding claim wherein, a manual override to the pointed region of interest can be activated, whereby the camera or the objects can be moved, by human or machine, so that a visible frame of reference, such as may be displayed with a bounding box, is aligned with an appropriate image that the neural net is looking for.

38. The system as claimed in any preceding claim wherein, the cognition layer comprises a thin neural network image training set or any type of deep neural net.

39. The system as claimed in any preceding claim wherein, the cognition layer operates by taking a single image given by the human and performing a number of alterations to that image in order to create a very large data set which creates and captures variances within the data and allows for generalizations within the data wherein the data set is then given to the thin neural network to complete the training of a model.

40. The system as claimed in claim 40 wherein, said images are made transparent, cropped, rotated, and have different backgrounds, lights and shadows applied.

41. The system as claimed in any preceding claim wherein, the cognition layer captures knowledge captured from the video frames used in the multi-factor confirmation to retrain the thin neural network so that new and better, or alternative processes can be captured.

42. The system as claimed in any preceding claim wherein the thin neural networks can be retrained with images taken from previous approved states.

43. The system as claimed in claim 42 wherein, the images will have been approved previously via a confidence index threshold (cit), thus images will have a confidence index somewhere between cit and 1.

44. A method for creating a video digital record of an event, the method comprising the steps of:
capturing live video;
passing the captured video frames through a queue-based data structure which defines a queue length for the video frames;
receiving a notification that an event of interest has occurred;
locating a predetermined number of frames in the queue based structure which were recorded before and after the time at which the event of interest occurred; and
retaining the predetermined number of frames for inspection or analysis.

45. The method as claimed in claim 44 wherein, the queue length is configurable by a user.

46. The method as claimed in claim 44 or 45 wherein, a frame rate for the video frames is configurable by a user.

47. The method as claimed in any of claims 44 to 46 wherein, the queue length and/or the frame rate can be adjusted based on the event which is being monitored.

48. The method as claimed in any of claims 44 to 47 wherein, the video digital record is created by having a video camera viewing an area of interest.

49. The method as claimed in claim 48 wherein, the video camera captures live video frames constantly.

50. The method as claimed in any of claims 44 to 49 wherein, the video frames are passed through the queue-based data structure on a first in, first out basis.

51. The method as claimed in any of claims 44 to 50 wherein, the notification that an event of interest has occurred is provided by an AI-driven vision system.

52. The method as claimed in any of claims 44 to 51 wherein, the notification that an event of interest has occurred is provided by an AI-driven vision system an IoT sensor.

53. The method as claimed in claims 44 to 51 wherein the method is used to create a video record in the production process execution system as claimed in claims 1 to 43.

54. A method for training a model to recognise features in an image, the method comprising the steps of:
creating an image-based dataset with which to train a model by:
receiving an image;
performing one or more alteration to the image data file to create a dataset;
providing the dataset to a thin neural network as training data; and
training the model.

55. The method as claimed in claim 55 wherein, the alterations are carried out in series such that subsequent alterations are performed on previously altered images.

56. The method as claimed in claim 54 or 55 wherein, the alterations are carried out on a previously altered image.

57. The method as claimed in any of claims 54 to 56 wherein, the alterations are carried out on an immediately previously altered image.

58. The method as claimed in any of claims 54 to 56 wherein, the method is used for the training of image based thin neural networks which work in conjunction with vision systems.

59. The method as claimed in any of claims 54 to 58 wherein, alterations comprise a plurality of alterations.

60. The method as claimed in any of claims 54 to 59 wherein, alterations comprise the removal of the background of the image by making it transparent.

61. The method as claimed in claim 60 wherein, the image with transparent background is cropped and re-scaled x number of times.

62. The method as claimed in any of claims 54 to 61 wherein, the cropped image is rotated at a number of increments of degrees between 0° and 360°.

63. The method as claimed in claim 62 wherein, the increments of degrees, y, is variable ranging from 1 to 360 degrees. to allow the vision system to correctly identify the object from many different angles, meaning that the trained model is now rotation invariant.

64. The method as claimed in any of claims 54 to 63 wherein, a number of background images, b, are added in order to represent the item being viewed in different scenes.

65. The method as claimed in claim 64 wherein, the background scenes represent the likely scenes in which the item may be viewed for example a person may be positioned on a road, at a desk or in a landscape.

66. The method as claimed in any of claims 54 to 66 wherein, a number of light effects, e, are added to the images.

67. The method as claimed in claim 66 wherein, the light effects include contrast or pixel intensity for the creation of a model which is able to account for changes in the lumens of the environment which it is testing for the presence of the trained model.

68. The method as claimed in any of claims 54 to 67 wherein, the images are saved and added to a collective data set, which can be used to train a machine learning model.

69. The method as claimed in any of claims 54 to 68 wherein, a number of variant images can be generated and added to the data set, allowing for the creation of a more robust model.

70. The method as claimed in any of claims 54 to 69 wherein, the dataset is large with respect to the amount of data in the original image.

71. The method as claimed in claims 54 to 70 wherein, the method is used to train a model to recognise features in an image in the production process execution system as claimed in claims 1 to 43.

72. A method for creating a digital record of a manufacturing process, the method comprising:
monitoring the manufacturing process
identifying when a manufacturing step or steps of the manufacturing process are complete, wherein upon completion of a step, the monitor captures a video record of the step.

73. The method as claimed in claim 72 wherein, the video record is saved to a database along with a number of key process variables.

74. The method as claimed in claim 72 or claim 73 wherein, the method is used to create a video record of the production process thin neural network image training set in accordance with the first aspect of the invention.

75. The method as claimed in any of claims 72 to 74 wherein, the method is used to create a record of the in accordance with the first aspect of the invention.

76. The method as claimed in any of claims 72 to 75 wherein, the key variable comprises one or more of operator ID, Product type, Unit Number, a Lot to which that unit belongs and a timestamp.

77. The method as claimed in any of claims 72 to 76 wherein, data relevant to the manufacturing process is recorded.

78. The method as claimed in any of claims 72 to 77 wherein, the data record comprises manufacturing variables, such as temperature, pressure or tolerances.

79. The method as claimed in any of claims 72 to 78 wherein, the data for quality control, traceability and accountability in real time, that encompasses visual and textual data.

80. The method as claimed in any of claims 72 to 79 wherein, the monitor is an industrial vision system.

81. The method as claimed in any of claims 72 to 80 wherein, the method monitors a complex manufacturing process through the use of an Industrial Vision System.

82. The method as claimed in any of claims 72 to 81 wherein, the method uses trained thin Neural Networks to identify when a manufacturing step or steps are complete.

83. The method as claimed in any of claims 72 to 82 wherein, upon completion of a step, a video record is captured.

84. The method as claimed in any of claims 72 to 83 wherein, the video record is saved to a database along with a number of key process variables such as the operator ID, the Product type and the Unit Number, the Lot to which that unit belongs, a timestamp and quality flag.

85. The method as claimed in claim 84 wherein, the data includes manufacturing variables, such as temperature, pressure or tolerances.

86. The method as claimed in claims 72 to 86 wherein, the method is used creating a digital record of a manufacturing process in the production process execution system as claimed in claims 1 to 43.
